(19) United States
(12) Patent Application Publication
(10) Pub. No.: US 2026/0318508 A1
(43) Pub. Date: Oct. 15, 2026

(54) LUMINAIRE ASSEMBLY AND PACKING METHOD

(71) Applicant: SIGNIFY HOLDING B.V., EINDHOVEN (NL)

(72) Inventors: PETER JOHANNES MARTINUS BUKKEMS, DEURNE (NL); GER VAN HEES, VOSSELAAR (BE)

(21) Appl. No.: 19/481,099

(22) PCT Filed: Apr. 18, 2024
(86) PCT No.: PCT/EP2024/060508

§ 371 Date: Nov. 3, 2025

(30) Foreign Application Priority Data
May 4, 2023 (EP) 23171493.2
May 4, 2023 (EP) 23171570.7

(51) Int. Cl. F21V 17/00; F21S 8/04; F21V 23/00; F21Y 105/16; F21Y 115/10

(52) U.S. Cl. CPC F21V 17/007; F21S 8/04; F21V 23/009; F21Y 2105/16; F21Y 2115/10

(57) ABSTRACT

The present invention relates to a luminaire assembly (10), comprising: a first luminaire (12a) comprising LEDs (14a), a first back plate (20a), and a first protruding component (18a) protruding from the first back plate and is positioned offset from and on one side (22a) of a centerline (24a) of the first back plate, whereas the first back plate on the other side (22a′) of the centerline (24a) is devoid of any protruding component; and a second luminaire (12b) comprising LEDs, a second back plate (20b), and a second protruding component (18b) protruding from the second back plate and positioned offset from and on one side (22b) of a centerline (24b) of the second back plate, where-as the second back plate on the other side (22b′) of the centerline (24b) is devoid of any protruding component, wherein the first luminaire and the second luminaire are packed back-to-back such that the first protruding component (18a) faces said other side (22b′) of the second back plate (20b) devoid of any protruding component and such that the second protruding component (18b) faces said other side (22a′) of the first back plate (20b) devoid of any protruding component.

### FIELD OF THE INVENTION

The present invention relates to luminaire assembly with two packed luminaires. The present invention relates to a method of packing two luminaires, in particular for transportation and/or storage. The present invention also relates to a luminaire, which may be packed with the aforementioned method.

### BACKGROUND OF THE INVENTION

Luminaires, for example for ceiling office lighting, may comprise a plurality of light emitting diodes (LEDs) adapted to emit light, and a driver for powering the LEDs. Luminaires may for example be panels that can be recessed in a T-grid ceiling.

### SUMMARY OF THE INVENTION

A problem when packing luminaires for transportation and/or storage may be the size of e.g. the driver, especially for luminaires with an otherwise low building height.

It is an object of the present invention to overcome this problem, and to provide an improved luminaire, luminaire assembly, and packing method.

According to a first aspect of the invention, this and other objects are achieved by a luminaire assembly or system, comprising: a first luminaire, wherein the first luminaire comprises a plurality of first light emitting diodes (LEDs) adapted to emit first LED light, a first back plate, and a first protruding component protruding from the first back plate, wherein the first protruding component is positioned offset from and on one side of a centerline of the first back plate, whereas the first back plate on the other side of the centerline is devoid of any protruding component; and a second luminaire, wherein the second luminaire comprises a plurality of second light emitting diodes adapted to emit second LED light, a second back plate, and a second protruding component protruding from the second back plate, and, wherein the second protruding component is positioned offset from and on one side of a centerline of the second back plate, whereas the second back plate on the other side of the centerline is devoid of any protruding component, wherein the first luminaire and the second luminaire are packed back-to-back such that the first protruding component faces said other side of the second back plate devoid of any protruding component and such that the second protruding component faces said other side of the first back plate devoid of any protruding component, and wherein each protruding component is selected from the group consisting of: a protruding electronic component, a driver for powering LEDs, a junction box, a sensor, a sensor enclosure, a battery, a battery enclosure, a connection component, and a wireless connection component.

The present invention is at least partly based on the understanding that by offsetting the protruding components and pack the luminaires back-to-back such that each protruding component faces a side of the back plate of the opposite luminaire without any significantly protruding component, the total height of the packed luminaries may be lower than the aggregated individual heights of the luminaires. A result is more luminaires per pallet, for a more sustainable way of transporting. This will also lead to lower transportation cost, as this is defined by volume. The two luminaires may also be packed in one common packaging rather than each luminaire in its own packaging, which reduces the amount of packaging material. Another result is less work for installer, as more luminaires could be transported at once, and less packaging material has to be removed.

“Significantly protruding component” may be construed as a component protruding more than 10 mm from the back plate. Furthermore, “each protruding component” in e.g. claim 1 may refer to the first protruding component, the second protruding component, and the “any protruding component”. The first and second luminaire may be identical.

The first and second luminaires may each have a maximum height in the range of 35-55 mm, such as 49.7 mm, wherein the first and second luminaires packed back-to-back have a total height in the range of 60-80 mm, such as 69.7 mm. For the exemplary heights of 49.7 mm and 69.7 mm, approximately 35% more luminaires may be fitted on one pallet.

The height of the first luminaire without the first protruding component may be lower than the height of the first protruding component, wherein the height of the second luminaire without the second protruding component is lower than the height of the second protruding component. Hence, the luminaires may be construed as having an otherwise low building height.

The first protruding component may be partly accommodated in a first hole in the first back plate, and further extend beyond the first back plate towards the second luminaire, wherein the second protruding component is partly accommodated in a second hole in the second back plate, and further extends beyond the second back plate towards the first luminaire. In this way, the first and second protruding components such as first and second drivers may be accessible on the front side of the respective back plate. Furthermore, this lowers the total building height of the luminaire, which in turn provides for a better packaging efficiency.

Each of the first and second back plates may be square or rectangular, wherein each of the first and second protruding components is arranged along one edge of the square or rectangular first and second back plates, respectively.

The luminaire assembly may further comprise a plurality of corner brackets adapted to position (such as fixate) and keep the first and second luminaires a predetermined distance from each other when the first and second luminaires are packed back-to-back. In this way, a space may be formed between the first and second back plates, in which space the first and second protruding components as well as any other lower or flexible components on the back plates may be protected from damage when the first and second luminaires are packed back-to-back.

Each corner of the first luminaire and each corner of the second luminaire may be provided with one corner bracket of said plurality of corner brackets, wherein each corner bracket of the first luminaire extends beyond the first back plate towards the second luminaire, and wherein each corner bracket of the second luminaire extends beyond the second back plate towards the first luminaire. Each corner bracket may for example extend 10-50 mm, preferably 10-25 mm, beyond the respective back plate.

Each corner bracket comprises at least one of (e.g. only one of or several of or all of): two portions arranged perpendicular to each other such that the corner bracket fits a corner of the first or second luminaire, wherein optionally a slit is provided at a distal end portion of the junction between said two portions for receiving a corresponding corner bracket of the other luminaire; a hole allowing connection of an earthquake protection cable (when the first/luminaire is mounted e.g. in a ceiling); a top T-grid connection tab; and a T-grid fixation lip optionally resting against a distal edge of a corresponding corner bracket of the other luminaire when the first and second luminaires are packed back-to-back.

Instead of having slits, at least some of the corner brackets could be somewhat loosely fixed, e.g. by not-fully-tightened screw fixation, so that the corner bracket(s) on one luminaire can give way to the corner bracket(s) of the other luminaire when packed back-to-back. In this case, when unpacking, the installer will need to tighten the fixation of the corner brackets before installation.

The T-grid fixation lip resting against a distal edge of a corresponding corner bracket of the other luminaire may position and keep the first and second luminaires the above-mentioned predetermined distance from each other when the first and second luminaires are packed back-to-back. Another option to position and keep the first and second luminaires the above-mentioned predetermined distance from each other when the first and second luminaires are packed back-to-back is to have a hole through corresponding corner brackets and fixate this with for example a screw or wire or cable tie.

The plurality of first light emitting diodes may be distributed in a plurality of first lighting modules of the first luminaire, wherein the plurality of second light emitting diodes are distributed in a plurality of second lighting modules of the second luminaire. The lighting modules may be removably attached to the back plate of the respective luminaire, so that the lighting modules can be individually removed from the luminaire and replaced by a new or repaired lighting module. This improves the sustainability of the luminaire.

The first lighting modules may be attached to the first back plate by a first plurality of torsion springs extending partially through openings in the first back plate, wherein the second lighting modules are attached to the second back plate by a second plurality of torsion springs extending partially through openings in the second back plate. The portions of the torsion springs extending through openings in the respective back plate may be protected in the above-mentioned space formed between the first and second back plates.

Each of the first and second luminaires may be an office lighting luminaire, in particular a recessed office lighting luminaire, such as a panel.

According to a second aspect of the invention, there is provided a packing method, comprising: providing a first luminaire, wherein the first luminaire comprises a plurality of first light emitting diodes adapted to emit first LED light, a first back plate, and a first protruding component protruding from the first back plate, wherein the first protruding component is positioned offset from and on one side of a centerline of the first back plate, whereas the first back plate on the other side of the centerline is devoid of any protruding component; providing a second luminaire, wherein the second luminaire comprises a plurality of second light emitting diodes adapted to emit second LED light, a second back plate, and a second protruding component protruding from the first back plate, and, wherein the second protruding component is positioned offset from and on one side of a centerline of the second back plate, whereas the second back plate on the other side of the centerline is devoid of any protruding component; and packing the first luminaire and the second luminaire back-to-back such that the first protruding component faces said other side of the second back plate devoid of any protruding component and such that the second protruding component faces said other side of the first back plate devoid of any protruding component, wherein each protruding component is selected from the group consisting of: a protruding electronic component, a driver for powering LEDs, a junction box, a sensor, a sensor enclosure, a battery, a battery enclosure, a connection component, and a wireless connection component. This aspect may exhibit the same or similar features and technical effects as the first aspect, and vice versa. The packing step may be performed manually or by a robot, for example.

In the packing method, one of the first and second luminaires may be rotated 180 degrees relative to the other one of the first and second luminaires (or equivalently both luminaires are rotated e.g. +90° and −90°, respectively). This may ensure that the first protruding component faces the other side of the second back plate devoid of any protruding component and that the second protruding component faces the other side of the first back plate devoid of any protruding component, since the first and second luminaires when they are initially provided typically are in the same orientation.

The packed first and second luminaires may be placed in a packaging, which packaging accommodating the packed first and second luminaires then is placed on a pallet for transportation and/or storage. The packaging may for example be a carton box.

According to a third aspect of the invention, there is provided luminaire, comprising: a plurality of light emitting diodes adapted to emit LED light; a back plate; and a protruding component protruding from the back plate, wherein the protruding component is positioned offset from and on one side of a centerline of the back plate, whereas the back plate on the other side of the centerline is devoid of any protruding component, and wherein each protruding component is selected from the group consisting of: a protruding electronic component, a driver for powering the LEDs, a junction box, a sensor, a sensor enclosure, a battery, a battery enclosure, a connection component, and a wireless connection component. This aspect may exhibit the same or similar features and technical effects as the first and/or second aspects, and vice versa.

Specifically, the protruding component may be partly accommodated in a hole in the back plate, and further extend rearwardly beyond the back plate.

Moreover, the luminaire may further comprise a plurality of corner brackets adapted to mount the luminaire in a ceiling grid. The plurality of corner brackets may further be adapted to position and keep the luminaire a predetermined distance from a corresponding second luminaire when the luminaire and the second luminaire are packed back-to-back.

It is appreciated that the first aspect of the invention may be construed as a luminaire assembly or system comprising two luminaires according to the third aspect of the invention.

It is noted that the invention relates to all possible combinations of features recited in the claims.

### BRIEF DESCRIPTION OF THE DRAWINGS

These and other aspects of the present invention will now be described in more detail, with reference to the appended drawings showing embodiments of the invention.

FIG. 1 is a perspective view of first and second luminaires before packing.

FIG. 2 is a side view of the first and second luminaires of FIG. 1 packed back-to-back.

FIG. 3 is a perspective view of the first and second luminaires of FIG. 1 packed back-to-back.

FIG. 4 is a perspective view showing corner brackets.

FIG. 5 is a rear view of a luminaire according to another embodiment.

Like reference numerals refer to like elements throughout.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled person.

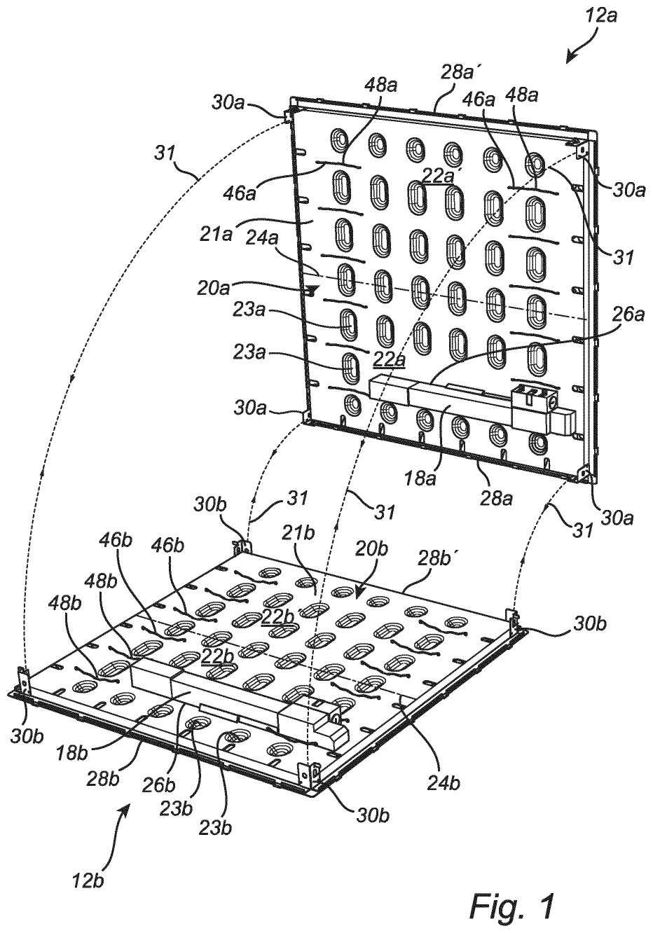

FIG. 1 shows a luminaire assembly (or luminaire system) 10 comprising a first luminaire 12a and a second luminaire 12b before packing. The first and second luminaires 12a-b may be identical. Each luminaire 12a-b may for example be an office lighting luminaire, in particular a recessed office lighting luminaire, such as a panel. Each luminaire 12a-b may for example have an overall square shape, e.g. measuring 2′×2′ or 600×600 mm.

The first luminaire 12a comprises a plurality of first LEDs 14a adapted to emit first LED light 16a, for example white LED light 16a.

The first LEDs 14a may be distributed in a plurality of first lighting modules 44 (see FIG. 3) of the first luminaire 12a. The first lighting modules 44 could also be referred to as first light modules. The first luminaire 12a may for example comprise six first lighting modules 44. Each first lighting module 44 may be elongated, e.g. have a rectangular shape, for example measuring 86×572 mm. The first lighting modules 44 may be arranged side by side in the first luminaire 12a. Each first lighting module 44 may for example comprise 4×16×2=128 first LEDs. Each first lighting module 44 may further comprise a plurality of reflector cups as well as lenses/optics for the plurality of first LEDs 14a. The first lighting modules 44 are preferably removably attached, so that the first lighting modules 44 can be individually removed from the first luminaire 12a from the front side and replaced by a new or repaired lighting module. The first lighting modules 44 may for example be attached to a first back plate 20a of the first luminaire 12a by a first plurality of torsion springs 46a extending partially through openings 48a in the first back plate 20a.

The first back plate 20a may form, or at least form part of, a first (luminaire) housing of the first luminaire 12a. The first back plate 20a may be square, for example measuring 580×580 mm. Moreover, the first back plate 20a may comprise a rear surface 21a, and an opposite, front surface. The first LEDs 14a may be arranged so that they have their backs directed against the front surface of the first back plate 20a (and emit the first LED light 16a (mainly) in the opposite direction). The first back plate 20a may comprise a plurality of dimples 23a in the rear surface 21a, and a plurality of corresponding protrusions (not shown) on the front surface of the first back plate 20a, which protrusions may contact the backsides of the first lighting modules 44. The first back plate 20a can for example be made of aluminum or steel or a plastic.

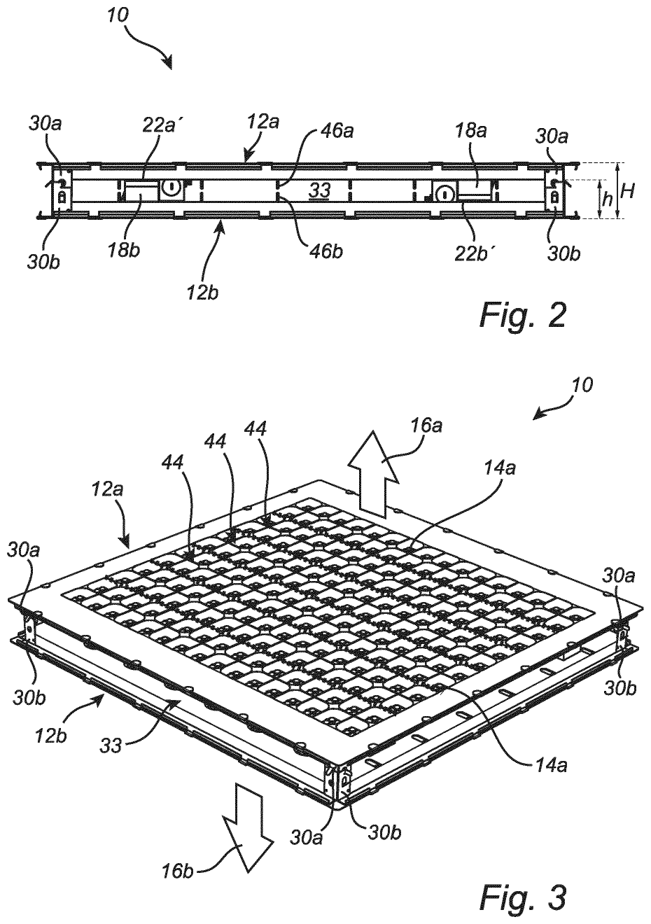

The first luminaire 12a further comprises a first protruding component 18a (rearwardly) protruding from (the rear surface 21a of) the first back plate 20a. The first protruding component may for example be a first driver 18a for powering the plurality of first LEDs 14a. The first protruding component 18a is positioned offset from, and on one side 22a of, a centerline 24a of the first back plate 20a. On the other side 22a′ of the centerline 24a, the first back plate 20a—specifically the rear surface 21a thereof—is devoid of any significantly protruding component. Hence, this portion of the rear surface 21a of the first back plate 20a is basically free from components. “Significantly protruding component” may be construed as a component protruding rearwardly more than 10 mm from the rear surface 21a of the first back plate 20a. The legs of the above-mentioned torsion springs 46a shown in FIGS. 1-2 could classify as not being a “significantly protruding component” and may hence be present on the other side 22a′ of the centerline 24a. Also present on the other side 22a′ of the centerline 24a could be a flexible component which when flexed protrudes less than 10 mm. The centerline 24a may be an imaginary line that is equidistant from opposing edges 28a and 28a′ of the first back plate 20a. The centerline 24a may for example divide the square first back plate 20a into (exactly) two equal rectangular portions, which rectangular portions also could be denoted by the reference signs 22a and 22a′.

Specifically, the first protruding component 18a may be arranged along one of the aforementioned edges 28a and 28a′ of the first back plate 20a, for example along edge 28a. Moreover, the first protruding component/driver 18a may be partly accommodated in a first hole 26a in the first back plate 20a, but it still extends rearwardly beyond the first back plate 20a.

The first luminaire 12a may further comprise corner brackets 30a, one corner bracket 30a per corner of first back plate 20a. Each corner bracket 30a may extend rearwardly beyond the first back plate 20a. The corner brackets 30a may among other things be adapted to mount the first luminaire 12a in a ceiling grid. The corner brackets 30a will be discussed in more detail hereinbelow.

Like the first luminaire 12a, the second luminaire 12b of the luminaire assembly (or system) 10 comprises a plurality of second LEDs adapted to emit second LED light 16b, for example white LED light 16b.

The second LEDs may be distributed in a plurality of second lighting modules, like the first lighting modules 44. The second lighting modules could also be referred to as second light modules. The second luminaire 12b may for example comprise six second lighting modules. Each second lighting module may be elongated, e.g. have a rectangular shape, for example measuring 86×572 mm. The second first lighting modules may be arranged side by side in the second luminaire 12b. Each second lighting module may for example comprise 4×16×2=128 second LEDs. Each second lighting module may further comprise a plurality of reflector cups as well as lenses/optics for the plurality of second LEDs. The second lighting modules are preferably removably attached, so that the second lighting modules can be individually removed from the second luminaire 12b from the front side and replaced by a new or repaired lighting module. The second lighting modules may for example be attached to a second back plate 20b of the second luminaire 12b by a second plurality of torsion springs 46b extending partially through openings 48b in the second back plate 20b.

The second back plate 20b may form, or at least form part of, a second (luminaire) housing of the second luminaire 12b. The second back plate 20b may be square, for example measuring 580×580 mm. Moreover, the second back plate 20b may comprise a rear surface 21b, and an opposite, front surface. The second LEDs may be arranged so that they have their backs directed against the front surface of the second back plate 20b (and emit the second LED light 16b (mainly) in the opposite direction). The second back plate 20b may comprise a plurality of dimples 23b in the rear surface 21b, and a plurality of corresponding protrusions (not shown) on the front surface of the second back plate 20b, which protrusions may contact the backsides of the second lighting modules. The second back plate 20b can for example be made of aluminum or steel or a plastic.

The second luminaire 12b further comprises a second protruding component 18b (rearwardly) protruding from (the rear surface 21b of) the second back plate 20b. The second protruding component may for example be a second driver 18b for powering the plurality of second LEDs. The second protruding component 18b is positioned offset from, and on one side 22b of, a centerline 24b of the second back plate 20b. On the other side 22b′ of the centerline 24b, the second back plate 20a—specifically the rear surface 21b thereof—is devoid of any significantly protruding component. Hence, this portion of the rear surface 21b of the second back plate 20b is basically free from components. “Significantly protruding component” may (again) be construed as a component protruding rearwardly more than 10 mm from the rear surface 21b of the second back plate 20b. The legs of the above-mentioned torsion springs 46b shown in FIGS. 1-2 could classify as not being a “significantly protruding component” and may hence be present on the other side 22b′ of the centerline 24b. Also present on the other side 22b′ of the centerline 24b could be a flexible component which when flexed protrudes less than 10 mm. The centerline 24b may be an imaginary line that is equidistant from opposing edges 28b and 28b′ of the second back plate 20b. The centerline 24b may for example divide the square second back plate 20b into (exactly) two equal rectangular portions, which rectangular portions also could be denoted by the reference signs 22b and 22b′.

Specifically, the second protruding component 18b may be arranged along one of the aforementioned edges 28b and 28b′ of the second back plate 20b, for example along edge 28b. Moreover, the second protruding component/driver 18b may be partly accommodated in a second hole 26b in the second back plate 20b, but it still extends rearwardly beyond the second back plate 20b.

The second luminaire 12b may further comprise corner brackets 30b, one corner bracket 30b per corner of second back plate 20b. Each corner bracket 30b may extend rearwardly beyond the second back plate 20b. The corner brackets 30b may among other things be adapted to mount the second luminaire 12b in a ceiling grid. The corner brackets 30b will be discussed in more detail hereinbelow.

In the luminaire assembly 10 of the first aspect of the present invention, and also in accordance with a packing method according to the second aspect of the present invention, the first luminaire 12a and the second luminaire 12b are packed (as illustrated by arrows 31 in FIG. 1) back-to-back such that the first protruding component/driver 18a faces the other side 22b′ of the second back plate 20b (which other side 22b′ does not have any protruding component) and such that the second protruding component/driver 18b faces the other side 22a′ of the first back plate 20b (which other side 22a′ too does not have any protruding component). The “resulting” first and second luminaires 12a-b packed back-to-back are shown in FIGS. 2-3.

Since the first and second luminaires 12a-b typically are in the same orientation when they are provided, one of them may be rotated 180 degrees relative to the other before they are packed back-to back. The packed first and second luminaires 12a-b may thereafter be placed in a packaging (not shown). The packaging may then be placed on a pallet (not shown) for transportation and/or storage.

The above-mentioned corner brackets 30a-b may (further) be adapted to position and keep the first and second luminaires 12a-b a predetermined distance from each other when the first and second luminaires 12a-b are packed back-to-back. In this way, a space 33 may be formed between the first and second back plates 20a-b, in which space 33 the first and second protruding components/drivers 18a-b as well as any other lower components on the back plates 20a-b may be accommodated. The “other lower components” may for example be portions (legs) of the aforementioned first and second plurality of torsion springs 46a-b, as indicated above.

As illustrated in FIG. 2, the first and second luminaires 12a-b may each have a maximum height h in the range of 35-55 mm, such as 49.7 mm, whereas the first and second luminaires 12a-b packed back-to-back may have a total height H in the range of 60-80 mm, such as 69.7 mm. If 10 mm average packaging thickness is added, one gets a minimum box of 70 mm (49.7+10+10) for a single luminaire 12a or 12b and 90 mm (69.7+10+10) for the double luminaire 12a-b. The total thickness of two single luminaires each with packaging is hence 2×70=140 mm, which means that approximately 35% more luminaires may be fitted on one pallet when they are packed back-to-back as in the present invention.

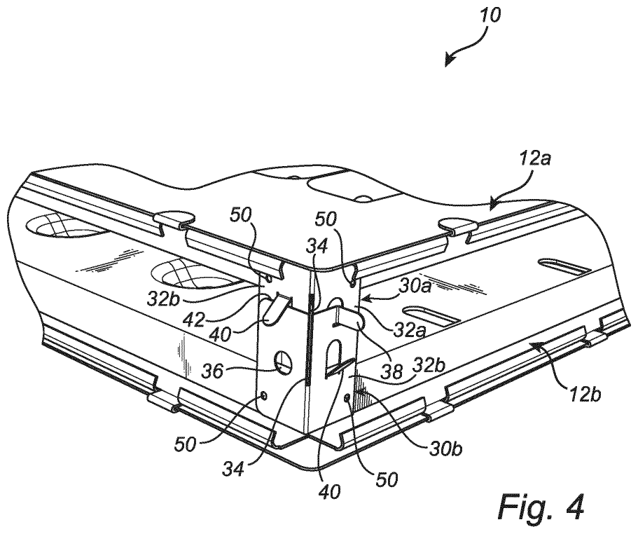

Turning to FIG. 4, each corner bracket 30a-b may comprise two portions 32a-b arranged perpendicular to each other, such that the corner bracket fits a corner of the first or second luminaire 12a-b. A distal slit 34 may be provided in the junction between the two perpendicular portions 32a-b. When the corner brackets 30a-b are slightly offset as in FIG. 4 (corner bracket 30a is “inside” corner bracket 30b), the slit 34 may beneficially accommodate an overlapping corner bracket at another corner of the luminaires 12a-b.

Each corner bracket 30a-b may further comprise an outwardly and rearwardly protruding (T-grid fixation) lip 40. The lip 40 may be provided on one of the two perpendicular portions 32a-b, such as portion 32b. The lip 40 may rests against a distal edge 42 of a corresponding corner bracket 30b when the first and second luminaires 12a-b are packed back-to-back, to keep the first and second luminaires 12a-b the above-mentioned predetermined distance from each other. Furthermore, the lip 40 may contact the T-bar when the first/second luminaire 12a-b is mounted in a T-grid ceiling.

Each corner bracket 30a-b may further comprise a hole 36 (e.g. provided in portion 32a) allowing connection of an earthquake protection cable, and a top/distal T-grid connection tab 38 e.g. provided in portion 32b. At some corners, the connection tab 38 could optionally extend through the hole 36 of a corresponding corner bracket when the first and second luminaires 12a-b are packed back-to-back. Moreover, the connection tab 38 may contact the T-bar when the first/second luminaire 12a-b is mounted in a T-grid ceiling. Furthermore, reference signs 50 designate (proximal) holes in the perpendicular portions 32a-b for fixing the corner bracket 30a-b to the respective back plate 20a-b.

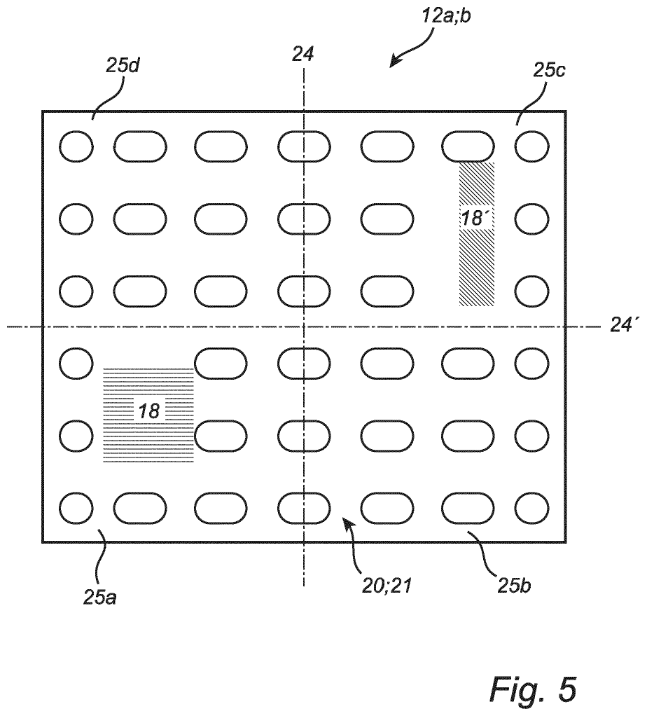

FIG. 5 shows a (first/second) luminaire 12a;b according to another embodiment. Here the centerline 24 and an additional centerline 24′ orthogonal to centerline 24 divide (the rear surface 21) of the back plate 20 into four quadrants 25a-d. Moreover, a protruding component 18 (such as a (smaller) driver) is positioned in quadrant 25a, i.e. offset on one side of centerline 24, whereas the back plate 20 on the other side of the centerline 24 in quadrant 25b is devoid of any (significantly) protruding component. Another protruding component 18′ (such as a junction box or communication module) is positioned in the mutually opposing quadrant 25c. That is, the other protruding component 18′ is positioned offset on one side of centerline 24 (and as well on the other side of centerline 24′ compared to protruding component 18), whereas the back plate 20 on the other side of the centerline 24 in quadrant 25d is devoid of any (significantly) protruding component. It is appreciated that two luminaires as in FIG. 5, rotated 90 degrees in relation to each other, can be packed back-to-back in a way that the protruding components 18 and 18′ of each luminaire face quadrants on the other luminaire devoid of any (significantly) protruding component.

The person skilled in the art realizes that the present invention by no means is limited to the preferred embodiments described above. On the contrary, many modifications and variations are possible within the scope of the appended claims. For example, instead of being a first/second driver 18a-b, the first/second protruding component may be selected from the group consisting of: a protruding electronic component, a junction box, a sensor, a sensor enclosure (to enable later sensor installation), a battery or battery enclosure (for emergency lighting applications), and a (wireless) connection component. The (wireless) connection component may for example be used to control the light of the luminaire, to make a local (e.g. Wi-Fi) network hot spot, to provide power and ethernet connection, to transmit data from the luminaire e.g. for energy metering and/or presence information sharing, etc.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

1. A luminaire assembly, comprising:
a first luminaire, wherein the first luminaire comprises a plurality of first light emitting diodes, LEDs, adapted to emit first LED light, a first back plate, and a first protruding component protruding from the first back plate, wherein the first protruding component is positioned offset from and on one side of a centerline of the first back plate, whereas the first back plate on the other side of the centerline is devoid of any protruding component; and
a second luminaire, wherein the second luminaire comprises a plurality of second light emitting diodes adapted to emit second LED light, a second back plate, and a second protruding component protruding from the second back plate, wherein the second protruding component is positioned offset from and on one side of a centerline of the second back plate, whereas the second back plate on the other side of the centerline is devoid of any protruding component,
wherein the first luminaire and the second luminaire are packed back-to-back such that the first protruding component faces said other side of the second back plate devoid of any protruding component and such that the second protruding component faces said other side of the first back plate devoid of any protruding component,
wherein each protruding component is selected from the group consisting of a protruding electronic component, a driver for powering LEDs, a junction box, a sensor, a sensor enclosure, a battery, a battery enclosure, a connection component, and a wireless connection component, and
wherein the luminaire assembly further comprises a plurality of corner brackets adapted to position and keep the first and second luminaires a predetermined distance from each other when the first and second luminaires are packed back-to-back.

2. A luminaire assembly according to claim 1, wherein the first and second luminaires each has a maximum height in the range of 35-55 mm, such as 49.7 mm, and wherein the first and second luminaires packed back-to-back have a total height in the range of 60-80 mm, such as 69.7 mm.

3. A luminaire assembly according to claim 1, wherein the height of the first luminaire without the first protruding component is lower than the height of the first protruding component, and wherein the height of the second luminaire without the second protruding component is lower than the height of the second protruding component.

4. A luminaire assembly according to claim 1, wherein the first protruding component is partly accommodated in a first hole in the first back plate, and further extends beyond the first back plate towards the second luminaire, and wherein the second protruding component is partly accommodated in a second hole in the second back plate, and further extends beyond the second back plate towards the first luminaire.

5. A luminaire assembly according to claim 1, wherein each of the first and second back plates is square or rectangular, and wherein each of the first and second protruding components is arranged along one edge of the square or rectangular first and second back plates, respectively.

6. A luminaire assembly according to claim 1, wherein each corner of the first luminaire and each corner of the second luminaire is provided with one corner bracket of said plurality of corner brackets, wherein each corner bracket of the first luminaire extends beyond the first back plate towards the second luminaire, and wherein each corner bracket of the second luminaire extends beyond the second back plate towards the first luminaire.

7. A luminaire assembly according to claim 1, wherein each corner bracket comprises at least one of:
two portions arranged perpendicular to each other such that the corner bracket fits a corner of the first or second luminaire, wherein optionally a slit is provided at a distal end portion of the junction between said two portions for receiving a corresponding corner bracket of the other luminaire;
a hole allowing connection of an earthquake protection cable;
a top T-grid connection tab; and
a T-grid fixation lip optionally resting against a distal edge of a corresponding corner bracket of the other luminaire when the first and second luminaires are packed back-to-back.

8. A luminaire assembly according to claim 1, wherein each of the first and second luminaires is an office lighting luminaire.

9. A packing method, comprising:
providing a first luminaire, wherein the first luminaire comprises a plurality of first light emitting diodes, LEDs, adapted to emit first LED light, a first back plate, and a first protruding component protruding from the first back plate, wherein the first protruding component is positioned offset from and on one side of a centerline of the first back plate, whereas the first back plate on the other side of the centerline is devoid of any protruding component;
providing a second luminaire, wherein the second luminaire comprises a plurality of second light emitting diodes adapted to emit second LED light, a second back plate, and a second protruding component protruding from the first back plate, and, wherein the second protruding component is positioned offset from and on one side of a centerline of the second back plate, whereas the second back plate on the other side of the centerline is devoid of any protruding component;
packing the first luminaire and the second luminaire back-to-back such that the first protruding component faces said other side of the second back plate devoid of any protruding component and such that the second protruding component faces said other side of the first back plate devoid of any protruding component,
wherein each protruding component is selected from the group consisting of: a protruding electronic component, a driver for powering LEDs, a junction box, a sensor, a sensor enclosure, a battery, a battery enclosure, a connection component, and a wireless connection component, and
positioning and keeping the first and second luminaires a predetermined distance from each other by means of a plurality of corner brackets.

10. A packing method according to claim 9, wherein one of the first and second luminaires is rotated 180 degrees relative to the other one of the first and second luminaires.

11. A packing method according to claim 9, wherein the packed first and second luminaires are placed in a packaging, which packaging accommodating the packed first and second luminaires then is placed on a pallet for transportation and/or storage.

12. (canceled)

13. (canceled)
